(19) United States
(12) Patent Application Publication
(10) Pub. No.: US 2019/0334264 A1
(43) Pub. Date: Oct. 31, 2019

(54) ELECTRONIC DEVICE

(71) Applicant: FANUC CORPORATION, Yamanashi (JP)

(72) Inventor: Makoto BEKKE, Yamanashi-ken (JP)

(21) Appl. No.: 16/388,377

(22) Filed: Apr. 18, 2019

(30) Foreign Application Priority Data
Apr. 25, 2018 (JP) 2018-084082

(51) Int. Cl. H01R 12/70; H01R 12/72; H01R 12/71

(52) U.S. Cl. CPC H01R 12/7076; H01R 12/716; H01R 12/721

(57) ABSTRACT

An electronic device includes: a casing having a slot; a circuit board; a first connector provided at an end of the circuit board in an insertion direction; a second connector provided in the slot and configured to be fitted with the first connector when the circuit board is inserted in the slot; pairs of guide rails provided in the slot in correspondence respectively with both ends of the circuit board in a direction intersecting the insertion direction of the circuit board, each pair of the guide rails including a first guide rail and a second guide rail extending along the insertion direction respectively on both surface sides of the circuit board inserted in the slot; and a pair of pressing members configured to, when the circuit board is inserted in the slot, press the circuit board so as to hold and sandwich the circuit board therebetween.

### CROSS-REFERENCE TO RELATED APPLICATION

This application is based upon and claims the benefit of priority from Japanese Patent Application No. 2018-084082 filed on Apr. 25, 2018, the contents of which are incorporated herein by reference.

### BACKGROUND OF THE INVENTION

### Field of the Invention

The present invention relates to an electronic device having a structure in which a first connector provided on a circuit board and inserted in a slot of a casing and a second connector provided on the slot are fitted together.

### Description of the Related Art

Electronic devices of this type include the electronic device disclosed in Japanese Laid-Open Patent Publication No. 2002-246772, for example. The electronic device of Japanese Laid-Open Patent Publication No. 2002-246772 includes a casing having a slot formed therein and a circuit board inserted in the slot. A first connector is soldered at an end of the circuit board in the direction in which the circuit board is inserted, and a pair of guide rails for guiding the insertion of the circuit board and a second connector are provided in the slot. When the circuit board is inserted in the slot, the first connector and the second connected are fitted together.

### SUMMARY OF THE INVENTION

In the electronic device of Japanese Laid-Open Patent Publication No. 2002-246772, the circuit board is fixed to the casing only at the fitted portion between the first connector and second connector and the soldered portion between the first connector and the circuit board (hereinafter referred to simply as “connected portions”).

In such an electronic device, when vibration is applied to the circuit board, for example, stresses are concentrated on the connected portions where the casing and the circuit board are connected together. As a result, the stresses applied to the connected portions act as loads, which may damage the connected portions and possibly the electronic device in turn.

Accordingly, an object of the present invention is to reduce stress applied to connected portions between a casing and a circuit board in an electronic device in which the circuit board is inserted in a slot of the casing.

According to an aspect of the present invention, an electronic device includes: a casing having a slot formed therein; a circuit board configured to be inserted in the slot; a first connector provided at an end of the circuit board in an insertion direction; a second connector provided in the casing and configured to be fitted with the first connector when the circuit board is inserted in the slot; pairs of guide rails provided in the slot in correspondence respectively with both ends of the circuit board in a direction intersecting the insertion direction, so as to guide insertion of the circuit board into the slot, each pair of the guide rails including a first guide rail and a second guide rail that are provided in the slot so as to extend along the insertion direction respectively on both surface sides of the circuit board inserted in the slot; and a pair of pressing members configured to, when the circuit board is inserted in the slot, press the circuit board so as to hold and sandwich the circuit board therebetween. According to the present invention, the circuit board is fixed in the casing by being pressed by the pair of pressing members, and as a result the stresses applied to the connected portions between the casing and the circuit board are reduced.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view showing the configuration of the entirety of an electronic device according to a first embodiment;

FIG. 2 is an exploded perspective view showing the configuration of part of the electronic device according to the first embodiment;

FIG. 3 is a schematic diagram showing a state in which a circuit board has been inserted in a slot according to the first embodiment;

FIG. 4 is a schematic diagram showing a state in which the circuit board has been inserted in a slot of an electronic device according to a first modification of the first embodiment;

FIG. 5 is an exploded perspective view showing the configuration of part of an electronic device according to a second modification of the first embodiment;

FIG. 6 is a perspective view showing the configuration of part of an electronic device according to a second embodiment;

FIG. 7 is a perspective view showing a state in which the circuit board is inserted in the slot of the electronic device according to the second embodiment; and

FIG. 8 is a perspective view showing the configuration of part of an electronic device according to a first modification of the second embodiment.

### DESCRIPTION OF THE PREFERRED EMBODIMENTS

The electronic device according to the present invention will be described in detail below in conjunction with preferred embodiments while referring to the accompanying drawings.

### Configuration of First Embodiment

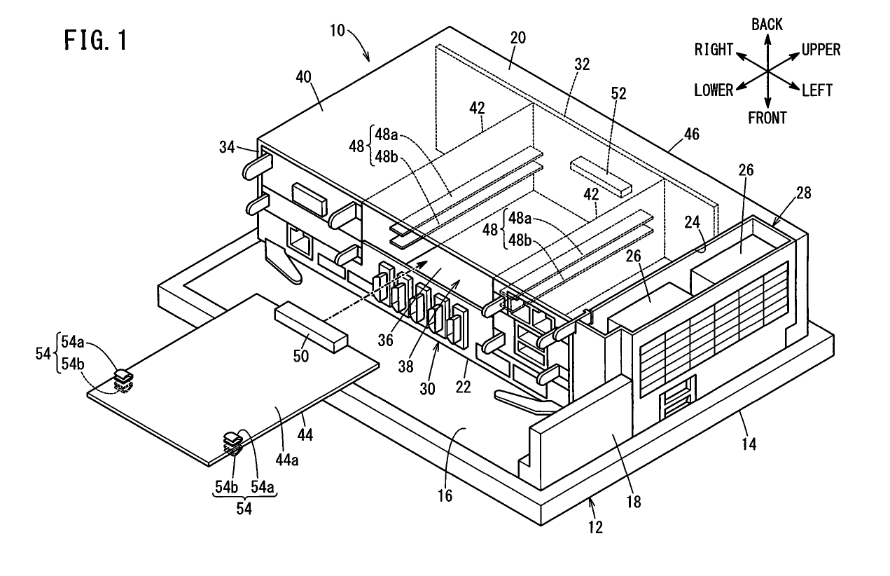

FIG. 1 is a perspective view showing the configuration of the entirety of an electronic device 10 according to a first embodiment.

As shown in FIG. 1, the electronic device 10 of this embodiment is a control device for controlling a machine tool, robot, injection molding machine, or wire electric discharge machine, for example. The electronic device 10 is provided to an indicator 12. The indicator 12 is a display unit, for example, and a liquid-crystal screen (not shown) is provided on a front surface 14 of the indicator 12. The screen of the indicator 12 need not necessarily be liquid crystal.

In the description below, the directions are indicated as up-down (upper-lower), right-left, and front-back directions seen from the front of the display screen of the indicator 12.

In the example of FIG. 1, the electronic device 10 and a user interface unit 18, which is connectable to external equipment (not shown), are detachably mounted on a back surface 16 of the indicator 12. When the electronic device 10 and the indicator 12 are capable of sending and receiving signals to and from each other through a wireless electric communication line, for example, the electronic device 10 and the indicator 12 may be disposed at positions separated from each other.

The electronic device 10 includes a box-shaped casing 20 that is detachably mounted on the back surface 16 of the indicator 12, and a bottom surface 22 of the casing 20 faces the back surface 16 of the indicator 12. In addition to the casing 20, the electronic device 10 includes a control unit 30 accommodated in the casing 20 and configured to control the indicator 12 and industrial machine, and a back plate 32 connected to the control unit 30.

Of the side surfaces of the casing 20 that adjoin its bottom surface 22, a fan unit 28 accommodating two fans 26 for cooling the interior of the casing 20 is detachably mounted to a side surface 24 that is positioned closer to the user interface unit 18 and extends along the up-down direction. The number of fan unit(s) 28 attached to the casing 20 and the number of fan(s) 26 accommodated in the fan unit 28 are not limited particularly. For example, three fans 26 may be accommodated in one fan unit 28.

Also, among the side surfaces of the casing 20 that adjoin its bottom surface 22, a lower surface 34 (a side surface on the lower side) adjacent to the side surface 24, to which the fan unit 28 is attached, has formed therein a plurality of openings 36 having different shapes or sizes.

The casing 20 has formed therein a plurality of slots 38 extending respectively from the plurality of openings 36 in a direction parallel to the side surface 24. That is, a plurality of partition plates 42 are provided in the casing 20 so as to extend from a top plate 40, opposite to the back surface 16 of the indicator 12, to the bottom surface 22. A plurality of spaces in the casing 20 that are partitioned by the bottom surface 22, the back plate 32, the top plate 40, and the plurality of partition plates 42 form the respective slots 38. Another plurality of partition plates extending in the right-left direction may be provided to divide the space in the casing 20 in the front-back direction so as to form a plurality of slots 38.

The back plate 32 is a connection board that is connected to a plurality of circuit boards 44. The back plate 32 is disposed on the depth side of the casing 20 on the upper side, i.e., on the depth side of the plurality of slots 38 on the upper side, and extends in parallel to the upper side surface of the casing 20 (its upper surface 46) and perpendicularly to the bottom surface 22. The back plate 32 is connected to the indicator 12 through a connector (not shown).

The circuit board 44 is a printed circuit board, for example, and electronic components and circuits (not shown) are mounted on a mount surface 44a of the circuit board 44. In the example of FIG. 1, the plurality of circuit boards 44 constitute the control unit 30.

FIG. 1 shows by dashed lines the configuration of the interior of the slot 38 in a case where one circuit board 44 is inserted or extracted into or from one slot 38. In FIG. 1, a direction in which the circuit board 44 is inserted corresponds to the upward direction, and a direction in which the circuit board 44 is extracted (i.e., the direction opposite to the insertion direction) corresponds to the downward direction.

Each of the plurality of slots 38 is provided with pairs of guide rails 48 each including a first guide rail 48a and a second guide rail 48b. The guide rails 48 of each pair are made of resin or metal, for example, and are fixed on a partition plate 42 or on an inner wall etc., forming a side surface of the casing 20, in correspondence respectively with both ends of the circuit board 44 in a direction intersecting the insertion direction (in the right-to-left direction).

The first guide rail 48a and second guide rail 48b extend along the up-down direction at both surface sides of the circuit board 44 inserted in the slot 38.

The circuit board 44 can be moved in the slot 38 along the insertion direction when both its ends are inserted between the guide rails 48 of the pairs. That is, in this embodiment, the circuit board 44 can be easily positioned, to some extent, with respect to the slot 38 in the front-back and right-left directions, by inserting the circuit board 44 between the guide rails 48.

Further, in this embodiment, a first connector 50 is provided at an end of the circuit board 44 that is located closer to the back plate 32 (i.e., at the end of the circuit board 44 on the insertion side), and the surface mount components on the circuit board 44 and the first connector 50 are connected together electrically. In this embodiment, it is assumed that the surface mount components on the circuit board 44 and the first connector 50 are joined together by soldering.

On the other hand, a plurality of second connectors 52 are provided on the back plate 32. The plurality of second connectors 52 are disposed respectively corresponding to the positions of the plurality of slots 38, and the second connectors 52 are fitted respectively to the first connectors 50 when the circuit boards 44 are inserted.

When the circuit board 44 is inserted in the slot 38, the circuit board 44 is guided to the back plate 32 by the pairs of guide rails 48, and the first connector 50 of the circuit board 44 and the second connector 52 of the back plate 32 are fitted together. Then the indicator 12 is electrically connected to the plurality of circuit boards 44 constituting the control unit 30, whereby the control unit 30 can control the indicator 12.

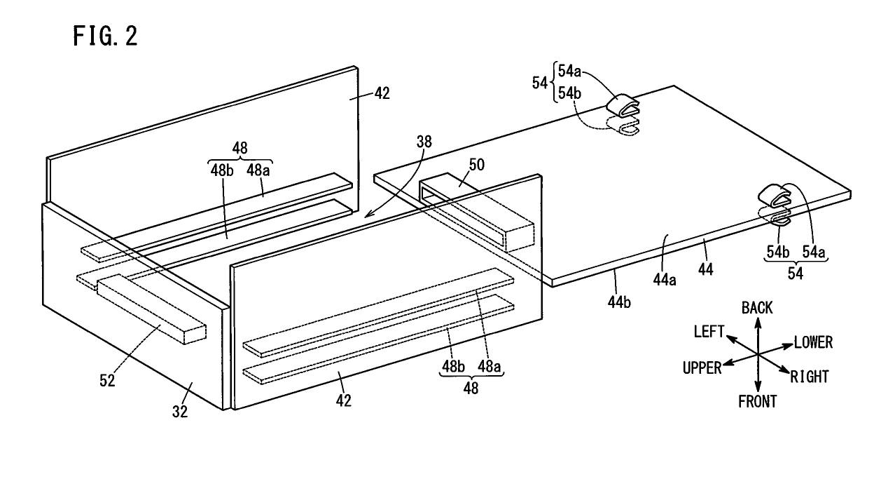

FIG. 2 is an exploded perspective view showing the configuration of part of the electronic device 10 according to the first embodiment.

As shown in FIG. 2, in this embodiment, pairs of pressing members 54 are disposed respectively at both ends of the circuit board 44 in the direction intersecting the insertion direction of the circuit board 44 (in the right-left direction) in such a manner that the pressing members 54 of each pair sandwich the circuit board 44. The pairs of pressing members 54 are members that have a pressing force, and may be springs having elasticity, for example.

In this embodiment, each pair of pressing members 54 is formed of a first pressing member 54a and a second pressing member 54b each of which is a spring bent in a U-shape. That is, as shown in FIG. 2, the first pressing members 54a reside on the mount surface 44a of the circuit board 44 respectively at both its ends in the right-left direction, and the second pressing members 54b reside on an underside surface 44b of the circuit board 44 (see FIG. 2) at positions corresponding to the first pressing members 54a. Further, the first pressing members 54a and the second pressing members 54b have their respective distal ends directed in the direction opposite to the insertion direction of the circuit board 44 (i.e., directed in the direction to the lower side), and the first pressing members 54a and the second pressing members 54b have their respective bent portions facing in the insertion direction of the circuit board 44 (i.e., directed in the direction to the upper side).

In the example of FIG. 2, the pairs of pressing members 54 are provided on the surfaces of the circuit board 44. Accordingly, the pairs of pressing members 54 can be mounted on the circuit board 44 by the same process as mounting of electronic components etc., on the circuit board 44. Therefore, in this embodiment, it is possible to avoid increase of the number of manufacturing process steps of the electronic device 10 or to avoid increased complication of the manufacturing process steps. Furthermore, in the example of FIG. 2, the distal ends of each pair of pressing members 54 provided on the circuit board 44 are directed in the direction opposite to the insertion direction of the circuit board 44, so that it is possible to prevent the distal ends of the pressing members 54 from becoming caught on the edges of the opening 36 when the circuit board 44 is inserted into the slot 38, thus preventing hindering of the insertion.

Now, a relationship between dimensions of the circuit board 44, a pair of the guide rails 48, and a pair of the pressing members 54 in this embodiment will be described. In this embodiment, an interval between the first guide rail 48a and the second guide rail 48b (the length in the front-back direction) is set to be smaller than the sum of the thickness of the circuit board 44 (the length in the front-back direction) and a height of the pair of pressing members 54 (the length in the front-back direction) in a state in which no external force is applied to the pair of pressing members 54, and to be larger than the sum of the thickness of the circuit board 44 and a height of the pair of pressing members 54 in a state in which the pair of pressing members 54 are compressed to maximum. Accordingly, when the circuit board 44 and the pair of pressing members 54 are inserted between the guide rails 48 of a pair, the pressing force by the pressing members 54 of the pair is applied to the circuit board 44.

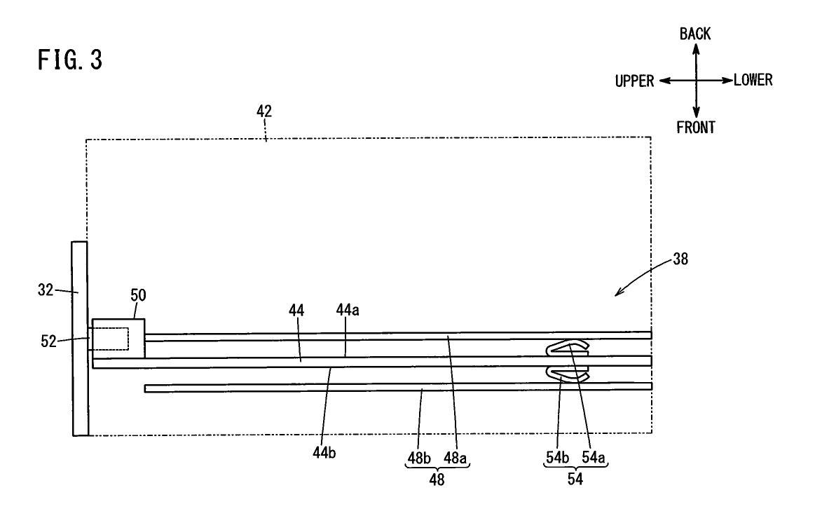

FIG. 3 is a schematic diagram showing a state in which the circuit board 44 has been inserted in the slot 38 according to the first embodiment.

As shown in FIG. 3, when the circuit board 44 has been inserted in the slot 38, the first pressing member 54a comes in close contact with the first guide rail 48a and applies a pressing force to the circuit board 44 toward the second guide rail 48b. Also, when the circuit board 44 is inserted in the slot 38, the second pressing member 54b comes in close contact with the second guide rail 48b and applies a pressing force to the circuit board 44 toward the first guide rail 48a.

Now, as has been mentioned earlier, in the conventional electronic device, vibration applied to the casing, for example, may cause stress concentrated on the connected portions, which may damage the connected portions.

However, each pair of pressing members 54 provided in the electronic device 10 according to this embodiment includes the first pressing member 54a that presses the circuit board 44 in a direction toward the second guide rail 48b between the first guide rail 48a and the circuit board 44, and the second pressing member 54b that presses the circuit board 44 in a direction toward the first guide rail 48a between the second guide rail 48b and the circuit board 44. Thus, the first pressing member 54a between the first guide rail 48a and the circuit board 44 applies a pressing force to the circuit board 44 in the direction toward the second guide rail 48b, and the second pressing member 54b between the second guide rail 48b and the circuit board 44 applies a pressing force to the circuit board 44 in the direction toward the first guide rail 48a.

The circuit board 44 is thus fixed in the slot 38 (casing 20) by the pressing forces that are applied from the pair of pressing members 54 to the circuit board 44.

This reduces stresses applied to the fitted portion between the casing 20 and the circuit board 44 and the connected portion (joined portion) between the circuit board 44 and the first connector 50. Further, this prevents damage to the connected portions that would otherwise be caused by the stress, and thus ensures vibration resistance of the electronic device 10. Furthermore, since a pair of pressing members 54 apply to the circuit board 44 pressing forces in opposite directions, the circuit board 44 does not bend or incline due to the pressing forces.

### [Modifications]

While the first embodiment has been described above as an example of the present invention, various modifications or improvements can of course be applied to the first embodiment above. It is clear from the recitation of claims that such variously modified or improved embodiments can be included in the technical scope of the present invention.

### (First Modification)

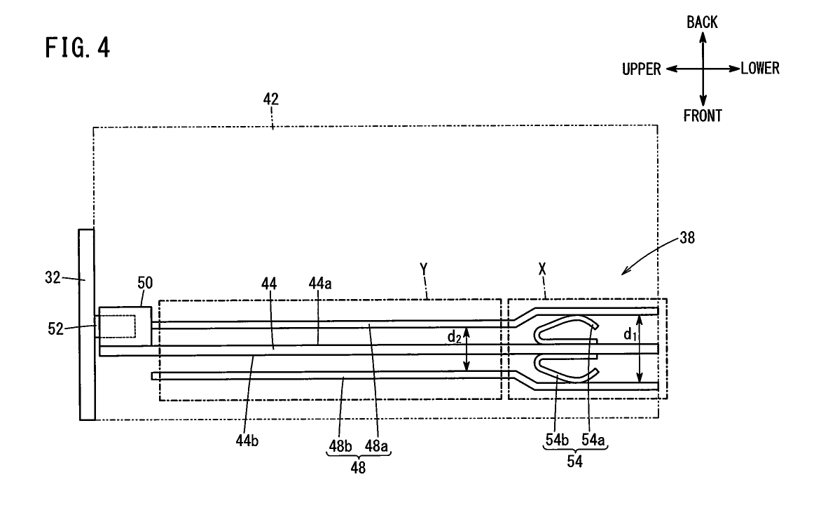

FIG. 4 is a schematic diagram showing a state in which the circuit board 44 has been inserted in the slot 38 of an electronic device 10 of a first modification.

As shown in FIG. 4, for example, the pair of guide rails 48 may have at least two intervals including an interval d₁ in a first region X of the slot 38 that lies closer to the opening 36 and an interval d₂ in a second region Y other than the first region X.

The interval d₁ is set under the same conditions as the interval between a pair of the guide rails 48 described in the first embodiment. That is, the length of the interval d₁ is set to be smaller than the sum of the thickness of the circuit board 44 and the height of the pair of pressing members 54 in an uncompressed state, and to be larger than the sum of the thickness of the circuit board 44 and the height of the pair of pressing members 54 in a state in which the pair of pressing members 54 are compressed to maximum. On the other hand, the interval d₂ is set to be smaller than the interval d₁.

In this way, the pair of guide rails 48 of this example has the first region X in which the pair of pressing members 54 are located when the first connector 50 and the second connector 52 are fitted together, and the second region Y other than the first region X, and the interval d₁ between the first guide rail 48a and the second guide rail 48b in the first region X is larger than the interval d₂ between the first guide rail 48a and the second guide rail 48b in the second region Y.

Further, in this example, the first region X is disposed on the side of the opening 36 of the slot 38. In the electronic device 10 of this example, similarly to the first embodiment, the circuit board 44 is fixed in the slot 38 by the application of the pressing forces to the circuit board 44 from the pairs of pressing members 54 in the first region X. In addition, in this example, inserting the circuit board 44 into the second region Y having the interval d₂ smaller than the interval d₁ allows the first connector 50 to be accurately guided to the second connector 52.

### (Second Modification)

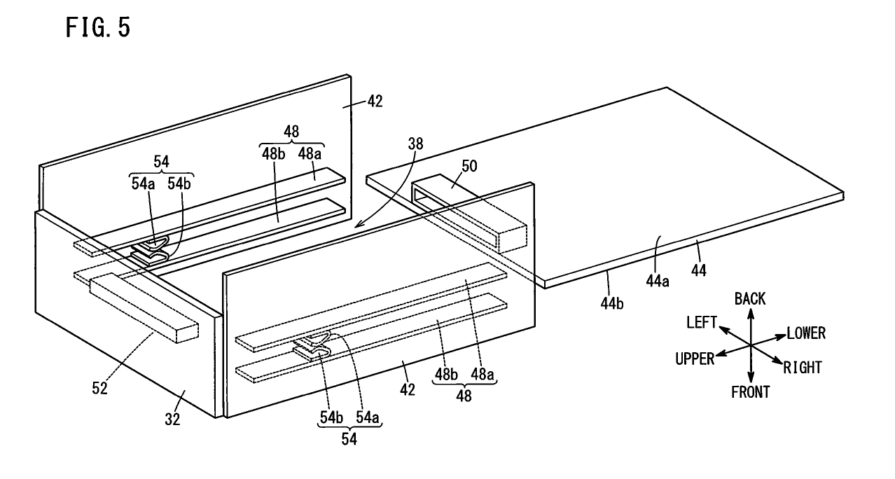

FIG. 5 is an exploded perspective view showing the configuration of part of an electronic device 10 of a second modification.

As shown in FIG. 5, for example, the pair of pressing members 54 may be disposed and fixed on the slot 38 (on the casing 20). In the example of FIG. 5, pressing members 54 of each pair are U-shaped springs having elasticity. In the example of FIG. 5, the pair of pressing members 54 are each bent such that their respective distal ends are directed to the insertion side of the circuit board 44 (in the direction to the upper side). When the circuit board 44 is being inserted into the slot 38, this prevents the distal ends of the pairs of pressing members 54 from becoming caught on the circuit board 44, and thus prevents hindering the insertion.

### (Third Modification)

For example, in the example of the first embodiment described above, a pair of pressing members 54 is located at each of both ends of the circuit board 44 in the right-left direction. However, a pair of pressing members 54 may be provided only on one side.

### Configuration of Second Embodiment

An electronic device 10 according to a second embodiment will now be described. The same constituent elements as those described in the first embodiment will be labeled by using the same reference numerals and overlapping descriptions will not be repeated.

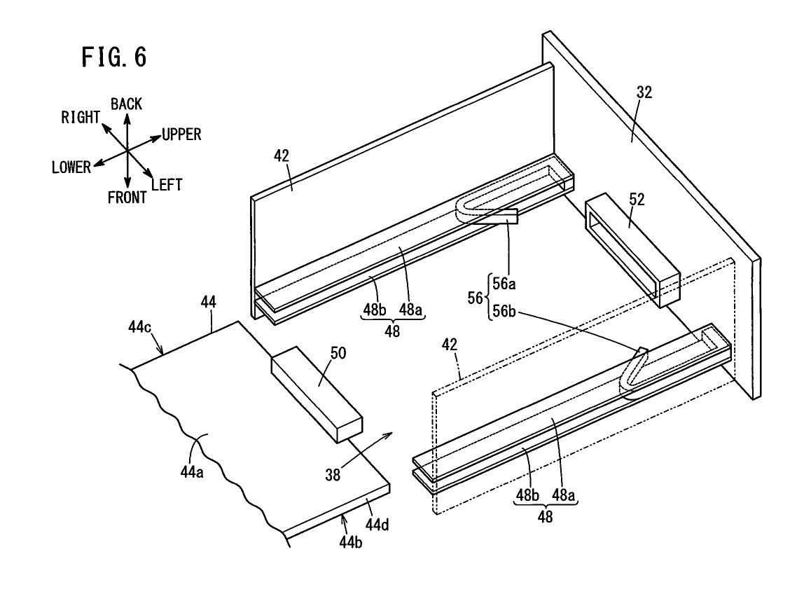

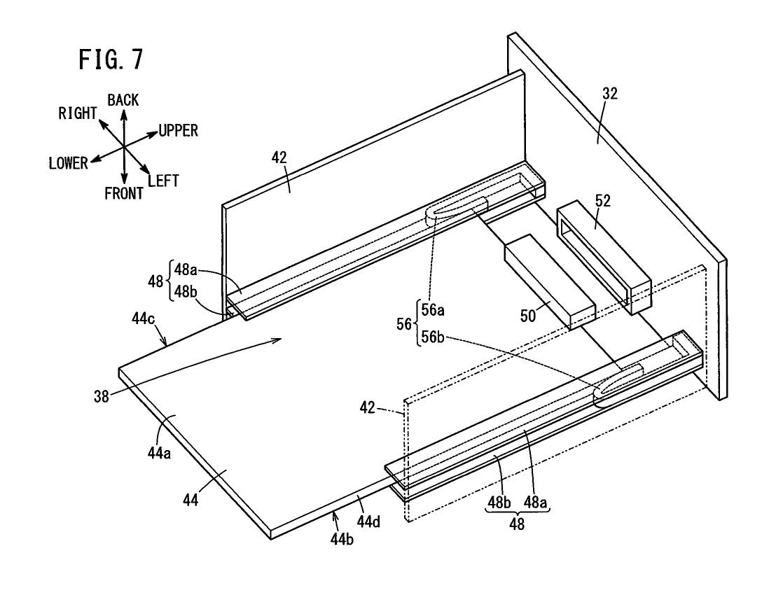

FIG. 6 is a perspective view showing the configuration of part of the electronic device 10 of the second embodiment. FIG. 7 is a perspective view showing a state in which the circuit board 44 is being inserted in the slot 38 of the electronic device 10 of the second embodiment.

As shown in FIGS. 6 and 7, in the electronic device 10 of this embodiment, a pair of pressing members 56 are provided respectively between the wall surfaces (partition plates 42) of the slot 38 and the circuit board 44. That is, in this embodiment, a first pressing member 56a is disposed between one end 44c of both ends of the circuit board 44 in the right-left direction and a wall surface of the slot 38 that faces the one end 44c. Further, a second pressing member 56b is disposed between the other end 44d of the both ends of the circuit board 44 in the right-left direction and another wall surface of the slot 38 that faces that other end 44d.

The pressing members 56 of the pair are members having pressing force, and they are springs having elasticity, for example.

In this embodiment, each of the pressing members 56 of the pair is assumed to be a spring that is bent in a U-shape. In this example, as shown in FIG. 6, the distal ends of the pressing members 56 of the pair are directed in the insertion direction of the circuit board 44 (in the direction to the upper side), and the bent portions of the pressing members 56 of the pair are directed in the direction opposite to the insertion direction of the circuit board 44 (in the direction to the lower side). Further, at least one of the distal ends of each pressing member 56 of the pair is fixed to the back plate 32. In this way, when the circuit board 44 is inserted into the slot 38, since the distal ends of the pressing members 56 of the pair are directed in the insertion direction of the circuit board 44, the distal ends of the pressing members 56 of the pair are not caught on the circuit board 44 and therefore do not hinder the insertion.

A relationship between dimensions of the circuit board 44, the pairs of guide rails 48, and the pair of pressing members 56 in this embodiment will be described. In this embodiment, a minimum distance in the right-left direction between the pressing members 56 of the pair is set to be smaller than a width of the circuit board 44 (the length in the right-left direction) when the pair of pressing members 56 are not compressed, and to be larger than the width of the circuit board 44 when the pair of pressing members 56 are compressed to maximum. Further, an interval between the first guide rail 48a and the second guide rail 48b (the length in the front-back direction) that form a pair of guide rails 48 is larger than a width of each pressing member 56 of the pair (the length in the front-back direction). Consequently, when the circuit board 44 and the pair of pressing members 56 are put between the pairs of guide rails 48, the pressing forces by the pair of pressing members 56 are applied to the circuit board 44.

In the electronic device 10 thus structured, when the circuit board 44 is inserted in the slot 38, the first pressing member 56a applies a pressing force to the circuit board 44 in the direction from one end 44c of the circuit board 44 to its other end 44d. In the same way, the second pressing member 56b applies a pressing force to the circuit board 44 in the direction from the other end 44d of the circuit board 44 to its one end 44c.

Then, the circuit board 44 is fixed in the slot 38 (casing 20) by the pressing forces that are applied from the pair of pressing members 56 to the circuit board 44.

Stresses applied to the fitted portion between the casing 20 and circuit board 44 and the connected portion between the circuit board 44 and the first connector 50 are thus reduced, which prevents damage to the connected portions that would be caused by the stresses, leading to ensured vibration resistance of the electronic device 10. Furthermore, since the pair of pressing members 56 apply pressing forces to the circuit board 44 in opposite directions, the circuit board 44 will not be bent or curved by the pressing forces.

### [Modifications]

While the second embodiment has been described above as an example of the present invention, various modifications or improvements can of course be applied to the second embodiment above. It is clear from the recitation of claims that such variously modified or improved embodiments can be included in the technical scope of the present invention.

### (First Modification)

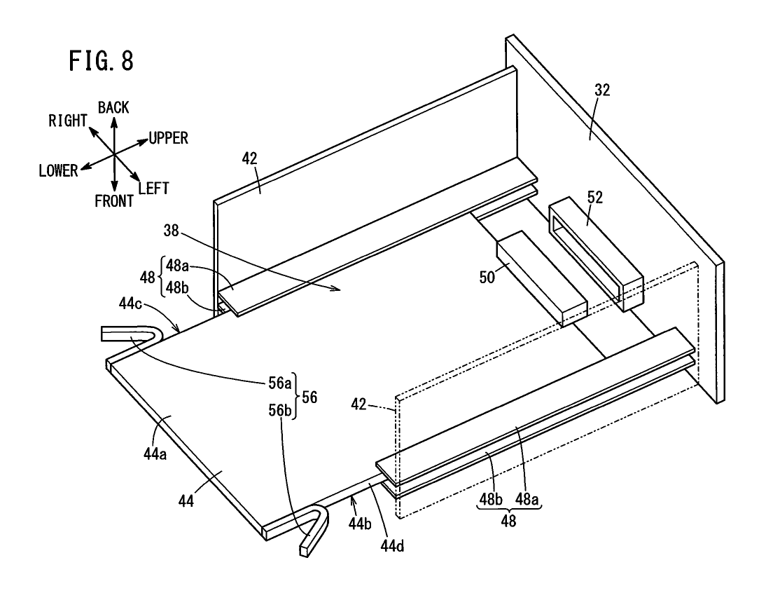

FIG. 8 is a perspective view showing the configuration of part of an electronic device 10 according to a first modification of the second embodiment.

For example, as shown in FIG. 8, a pair of pressing members 56 may be fixed respectively to one end 44c and the other end 44d of the circuit board 44. In this case, when the pair of pressing members 56 are bent in a U-shape as shown in FIG. 8, for example, the distal ends of the pair of pressing members 56 are directed in the direction opposite to the insertion direction of the circuit board 44 (directed in the direction to the lower side), and then, when the circuit board 44 is inserted into the slot 38, the pair of pressing members 56 are prevented from being caught on the edges of the opening 36 of the slot 38, and thus the insertion of the circuit board is not hindered.

### (Second Modification)

In addition to the above-described first modification of the second embodiment, a pair of pressing members 56 may be fixed on wall surfaces of the slot 38, for example.

### (Third Modification)

The above-described embodiments and modifications may be arbitrarily combined in a range where no contradiction is incurred.

### Technical Ideas Obtained from Embodiments

Technical ideas that can be grasped from the embodiments and modifications above will be recited below.

The electronic device (10) includes: a casing (20) having a slot (38) formed therein; a circuit board (44) configured to be inserted in the slot (38); a first connector (50) provided at an end of the circuit board (44) in an insertion direction; a second connector (52) provided in the casing (20) and configured to be fitted with the first connector (50) when the circuit board (44) is inserted in the slot (38); pairs of guide rails (48) provided in the slot in correspondence respectively with both ends of the circuit board (44) in a direction intersecting the insertion direction, so as to guide insertion of the circuit board (44) into the slot (38), each pair of the guide rails (48) including a first guide rail (48a) and a second guide rail (48b) that are provided in the slot (38) so as to extend along the insertion direction respectively on both surface sides of the circuit board (44) inserted in the slot (38); and a pair of pressing members (54, 56) configured to, when the circuit board (44) is inserted in the slot (38), press the circuit board (44) so as to hold and sandwich the circuit board (44) therebetween.

Then, the circuit board (44) is fixed in the casing (20) by being pressed by the pair of pressing members (54, 56). This reduces stresses applied to the connected portions between the casing (20) and the circuit board (44), and thus ensures vibration resistance of the electronic device (10).

The pair of pressing members (54) may include: a first pressing member (54a) configured to press the circuit board (44) between the first guide rail (48a) and the circuit board (44) in a direction toward the second guide rail (48b); and a second pressing member (54b) configured to press the circuit board (44) between the second guide rail (48b) and the circuit board (44) in a direction toward the first guide rail (48a). Then the circuit board (44) can be fixed in the slot (38) and thus in the casing (20). This reduces stresses applied to the fitted portion between the casing (20) and the circuit board (44) and to the connected portion between the circuit board (44) and the first connector (50), and thus ensures vibration resistance of the electronic device (10).

The pair of guide rails (48) may have: a first region (X) in which the pair of pressing members (54) are located when the first connector (50) and the second connector (52) are fitted together; and a second region (Y) other than the first region (X). An interval between the first guide rail (48a) and the second guide rail (48b) in the first region (X) may be larger than an interval between the first guide rail (48a) and the second guide rail (48b) in the second region (Y). The circuit board (44) is thus fixed in the slot (38) and thus in the casing (20). At the same time, the first connector (50) is accurately guided to the second connector (52).

The first region (X) of the electronic device (10) may be provided on the side of an opening (36) of the slot (38). With this configuration, the circuit board (44) is fixed in the slot (38) and thus in the casing (20). At the same time, the first connector (50) is accurately guided to the second connector (52).

The pair of pressing members (56) may include: a first pressing member (56a) configured to, when the circuit board (44) is inserted in the slot (38), press the circuit board (44) between an inner wall of the slot (38) that faces one end (44c) of the both ends of the circuit board (44) and the one end (44c), in a direction toward the other end (44d) of the both ends of the circuit board (44); and a second pressing member (56b) configured to, when the circuit board (44) is inserted in the slot (38), press the circuit board (44) between an inner wall of the slot (38) that faces the other end (44d) of the both ends of the circuit board (44) and the other end (44d), in a direction toward the one end (44c) of the circuit board (44). Then, the circuit board (44) is fixed in the slot (38) and thus in the casing (20). This reduces stresses applied to the fitted portion between the casing (20) and the circuit board (44) and to the connected portion between the circuit board (44) and the first connector (50), and thus ensures vibration resistance of the electronic device (10).

The pair of pressing members (54, 56) may be fixed on the side of the slot (38). Then, the circuit board (44) is fixed in the slot (38) and thus in the casing (20) by being pressed by the pair of pressing members (54, 56). This reduces stresses applied to the connected portions between the casing (20) and the circuit board (44), and thus ensures vibration resistance of the electronic device (10). The pair of pressing members (54, 56) of the electronic device (10) may be fixed to the circuit board (44). Then, the circuit board (44) is pressed by the pair of pressing members (54, 56), and the circuit board (44) is fixed in the slot (38) and thus in the casing (20). This reduces stresses applied to the connected portions between the casing (20) and the circuit board (44), and thus ensures vibration resistance of the electronic device (10).

What is claimed is:

1. An electronic device comprising:
a casing having a slot formed therein;
a circuit board configured to be inserted in the slot;
a first connector provided at an end of the circuit board in an insertion direction;
a second connector provided in the casing and configured to be fitted with the first connector when the circuit board is inserted in the slot;
pairs of guide rails provided in the slot in correspondence respectively with both ends of the circuit board in a direction intersecting the insertion direction, so as to guide insertion of the circuit board into the slot, each pair of the guide rails including a first guide rail and a second guide rail that are provided in the slot so as to extend along the insertion direction respectively on both surface sides of the circuit board inserted in the slot; and
a pair of pressing members configured to, when the circuit board is inserted in the slot, press the circuit board so as to hold and sandwich the circuit board therebetween.

2. The electronic device according to claim 1, wherein the pair of pressing members includes:
a first pressing member configured to press the circuit board between the first guide rail of at least one pair of the guide rails and the circuit board in a direction toward the second guide rail of the at least one pair; and
a second pressing member configured to press the circuit board between the second guide rail of the at least one pair and the circuit board in a direction toward the first guide rail of the at least one pair.

3. The electronic device according to claim 1, wherein the pair of guide rails has:
a first region in which the pair of pressing members are located when the first connector and the second connector are fitted together; and
a second region other than the first region, and
wherein an interval between the first guide rail and the second guide rail in the first region is larger than an interval between the first guide rail and the second guide rail in the second region.

4. The electronic device according to claim 3, wherein the first region is provided on a side of an opening of the slot.

5. The electronic device according to claim 1, wherein the pair of pressing members includes:
a first pressing member configured to, when the circuit board is inserted in the slot, press the circuit board between an inner wall of the slot that faces one end of the both ends of the circuit board and the one end, in a direction toward another end of the both ends of the circuit board; and
a second pressing member configured to, when the circuit board is inserted in the slot, press the circuit board between an inner wall of the slot that faces the other end of the both ends of the circuit board and the other end, in a direction toward the one end of the circuit board.

6. The electronic device according to claim 1, wherein the pair of pressing members are fixed on a side of the slot.

7. The electronic device according to claim 1, wherein the pair of pressing members are fixed on the circuit board.
